(19) United States
(12) Patent Application Publication
(10) Pub. No.: US 2011/0145705 A1
(43) Pub. Date: Jun. 16, 2011

(54) CONTROL METHOD OF USER INTERFACE

(76) Inventors: Wen-Jiunn Cheng, TAIPEI CITY (TW); Chung-Hsiang Huang, TAIPEI CITY (TW)

(21) Appl. No.: 12/952,204

(22) Filed: Nov. 23, 2010

(30) Foreign Application Priority Data
Dec. 15, 2009 (TW) 098142846

(51) Int. Cl. G06F 3/041

(52) U.S. Cl. 715/702

(57) ABSTRACT

This invention provides a method for controlling a user interface of an electronic device. The electronic device has a touch screen. The control method includes the following steps. A first area and a second area are defined on the touch screen. A plurality of options of a first group are displayed in the second area. An operation of a user in the second area is determined. If the operation is a click, contents corresponding to one of the options of the first group clicked by the user are displayed in the first area. If the operation is a slide, a plurality of options of a second group are displayed in the second area, while an image displayed in the first area is unchanged.

### CROSS-REFERENCE TO RELATED APPLICATIONS

This Non-provisional application claims priority under 35 U.S.C. §119(a) on Patent Application No(s). 098142846 filed in Taiwan, Republic of China on Dec. 15, 2009, the entire contents of which are hereby incorporated by reference.

### BACKGROUND OF THE INVENTION

1. Field of the Invention

This invention relates to a control method of a user interface and, more particularly, to a control method of a user interface operated via a slide.

2. Description of the Related Art

In the modern life, various kinds of portable electronic devices, such as a cell phone, a personal digital assistant (PDA), a portable game machine and so on, have gradually become one of necessary articles. Further, with development of touch technology, various kinds of the portable electronic devices gradually use touch interfaces as human-computer communication interfaces. Therefore, user interfaces corresponding to touch modes are gradually paid attention to by manufacturers.

FIG. 1A is a schematic diagram showing a conventional user interface 1. In FIG. 1A, the user interface 1 is divided into an index area 11 and an operation area 12. The index area 11 may usually have a plurality of options 111. Thus, a user only needs to click one of the options 111, and contents of the option 111 may be displayed in the operation area 12.

Since a display screen of a portable electronic device is small, to completely display the user interface 1 on the display screen, the index area 11 cannot have too many options 111. However, with increase of function requirements, the number of the options 111 certainly has to increase. If the number of the options 111 is increased by reducing the area of the options 111, the user may not easily select correctly when clicking.

In addition, FIG. 1B is a schematic diagram showing another user interface 2. In FIG. 1B, the user interface 2 can be similarly divided into an index area 21 and an operation area 22. However, to increase the number of options 211, the options 211 are divided into different groups, and the user can rely on an arrow icon 212 to turn a page for changing the options 211 of different groups. However, the arrow icon 212 may occupy the limited area of the index area 21, and if the arrow icon 212 is too small, it may be inconvenient for the user to click.

### BRIEF SUMMARY OF THE INVENTION

According to the above, this invention is to provide a control method of a user interface easily operated by a user and capable of containing more function options.

The invention provides a method for controlling a user interface of an electronic device. The electronic device has a touch screen. The control method includes the following steps. A first area and a second area are defined on the touch screen. A plurality of options of a first group are displayed in the second area. An operation of a user in the second area is determined. If the operation is a click, contents corresponding to one of the options of the first group clicked by the user are displayed in the first area. If the operation is a slide, a plurality of options of a second group are displayed in the second area, while an image displayed in the first area is unchanged.

In one embodiment of the invention, if the operation is the slide, the control method may further include the following step. A sliding direction of the slide is determined.

In one embodiment of the invention, a group number of the first group may be n, and n may be an integer between a minimum value one and a maximum value N. If the slide is along a first direction, a group number of the second group is n+1. If the group number of the first group is N and the slide is along the first direction, the group number of the second group is one.

In one embodiment of the invention, if the slide is along a second direction, a group number of the second group may be n−1. If the group number of the first group is one and the slide is along the second direction, the group number of the second group is N.

In one embodiment of the invention, if the operation is the slide, the options of the first group displayed in the second area may respectively present a predetermined effect and may change to the options of the second group. The predetermined effect may be turning, rotation, or fading out, or a combination thereof.

To sum up, according to the control method of the user interface in the invention, the first area and the second area are defined on the touch screen, and a plurality of the options of the first group are displayed in the second area. Therefore, when the user clicks one of the options in the second area, the first area may display the contents corresponding to the option clicked by the user. While when the user slides in the second area, the second area may display the second group having a plurality of the options, and the image displayed in the first area is unchanged.

Since the user can change between different groups in the second area via the slide, the second area can contain more options via increasing more groups. Further, since the user can directly change between different groups via the slide without relying on the additional icon for turning pages in the prior art, the second area can also display larger icons to facilitate the click by the user. In addition, when the user operates in the first area, the user can still select different icons in the second area. Thereby, when the user is to switch to the next application program, he does not need to exit from the former one first, further improving convenience in use.

These and other features, aspects, and advantages of the present invention will become better understood with regard to the following description, appended claims, and accompanying drawings.

### BRIEF DESCRIPTION OF THE DRAWINGS

FIG. 1A and FIG. 1B are schematic diagrams showing different conventional user interfaces;

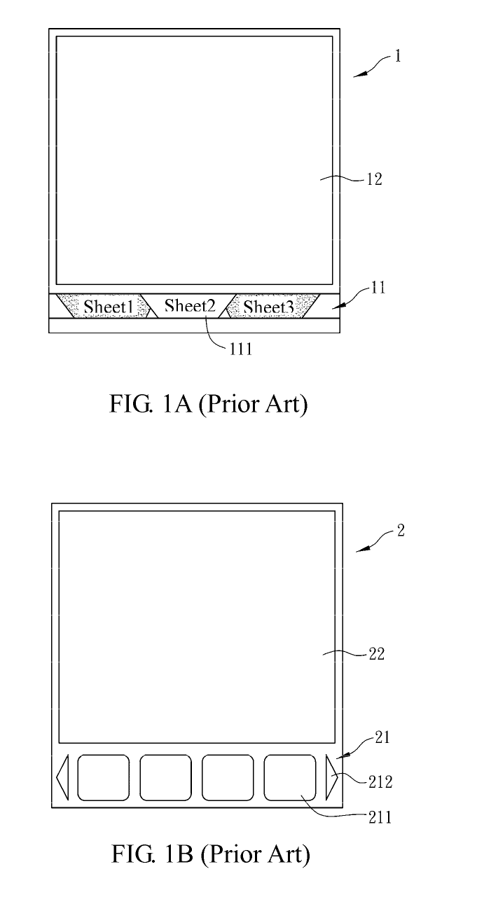

FIG. 2 is a flow chart showing a control method of a user interface according to one preferred embodiment of the invention;

FIG. 3A and FIG. 3B are schematic diagrams showing a user interface in different using states according to one preferred embodiment of the invention; and

FIG. 4 is a flow chart showing a control method of a user interface in another form according to one preferred embodiment of the invention.

### DETAILED DESCRIPTION OF THE INVENTION

A control method of a user interface in preferred embodiments of this invention is described hereinbelow according to related drawings, and the same elements are marked by the same reference numbers.

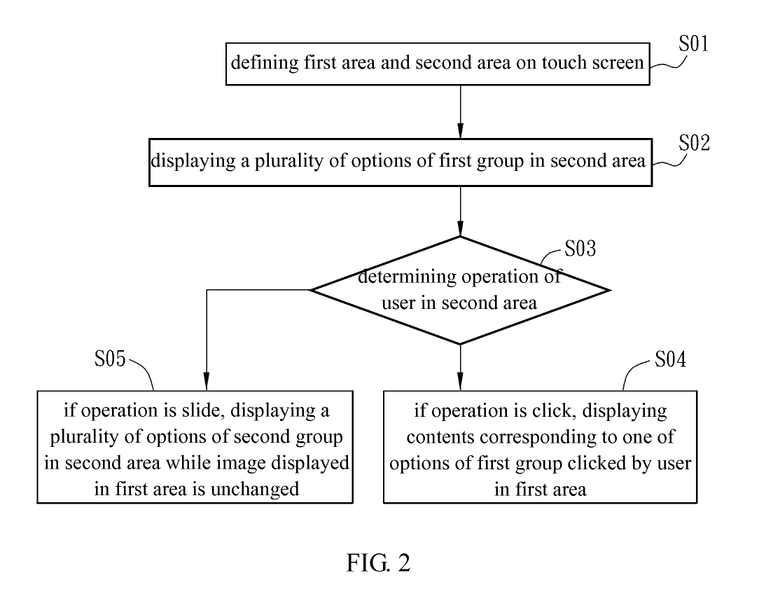

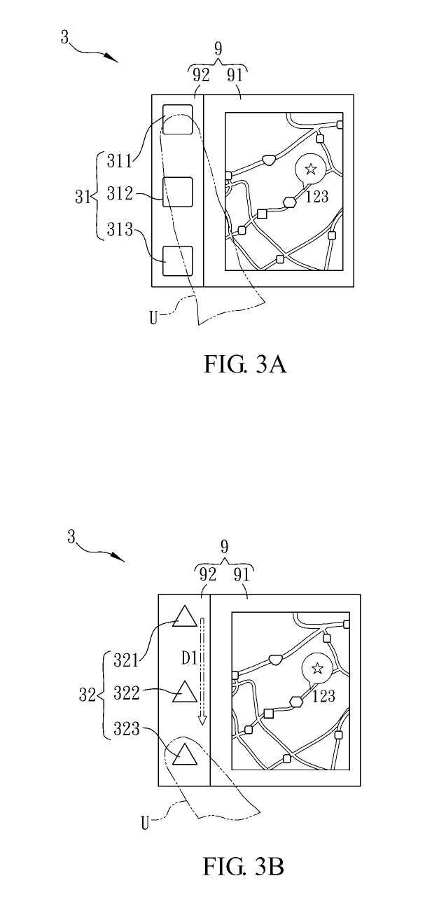

Please refer to FIG. 2 and FIG. 3A. FIG. 2 is a flow chart showing a control method of a user interface 3 according to one preferred embodiment of the invention. FIG. 3A is a schematic diagram showing the user interface 3 in a using state in the embodiment. The control method of the user interface 3 in the embodiment can be used for an electronic device. The electronic device may be a computer notebook, a personal digital assistant (PDA), a global positioning system (GPS), a digital still camera, a translator, an MP3 playing device, an MP4 playing device, a portable game device, a mobile communication device and so on. However, the invention is not limited thereto. Further, the electronic device has a touch screen 9. The control method includes step S01 to step S05.

In step S01, a first area 91 and a second area 92 are defined on the touch screen 9. The first area 91 is an operation area, and the second area 92 is an index area. The touch screen 9 may be a resistive touch screen, a capacitive touch screen, an acoustic wave touch screen, an optical touch screen, or an electromagnetic touch screen. The sizes of the first area 91 and the second area 92 are not limited.

In step S02, a plurality of options 311, 312, and 313 of a first group 31 are displayed in the second area 92. The size and number of the options 311, 312, and 313 are not limited. In the embodiment, three options 311, 312, and 313 are taken for example, and the options 311, 312, and 313 can represent application programs having different functions, respectively.

In step S03, an operation of a user U in the second area 92 is determined. In step S04, if the operation is a click, contents corresponding to one of the options 311, 312, and 313 of the first group 31 clicked by the user U are displayed in the first area 91. Corresponding to touch screens 9 with different structures, the user U can click directly by hands or by an object (such as a stylus). In the embodiment, the user U clicks directly by hands. However, the invention is not limited thereto. In the embodiment, the contents may be map information of a GPS. However, the invention is not limited thereto.

Therefore, the user U can click one of the options 311, 312, and 313 located in the second area 92, and the first area 91 may display the contents corresponding to the option 311 clicked by the user U. Thereby, the user can use a function corresponding to the option 311 in the first area 91.

Then, please refer to FIG. 2 and FIG. 3B. FIG. 3B is a schematic diagram showing the user interface 3 in another using state in the embodiment. In step S05, if the operation is a slide, a plurality of options 321, 322, and 323 of a second group 32 are displayed in the second area 92, and an image displayed in the first area 91 is unchanged. The size and number of the options 321, 322, and 323 are not limited. Similarly, in the embodiment, three options 321, 322, and 323 are taken for example, and the options 321, 322, and 323 can represent different functions, respectively. Certainly, the size and number of the options 321, 322, and 323 can be different from that of the options 311, 312, and 313.

In addition, the first group 31 and the second group 32 represent different functions, respectively. Further, the options 311, 312, and 313 of the first group 31 and the options 321, 322, and 323 of the second group 32 also represent different functions, respectively. In other words, the options 311, 312, and 313 respectively represent application programs having different functions, the options 321, 322, and 323 respectively represent application programs having different functions, and the options 311, 312, and 313 and the options 321, 322, and 323 also respectively represent application programs having different functions. For example, the first group 31 may represent a music function, and the options 311, 312, and 313 of the first group 31 may respectively represent different music playing programs or contents such as a Chinese gold song, an English old song, and an instrumental melody. Further, the second group 32 may represent a game function, and the options 321, 322, and 323 of the second group 32 may respectively represent different game programs such as a solitaire, an automobile race, and an intelligence test.

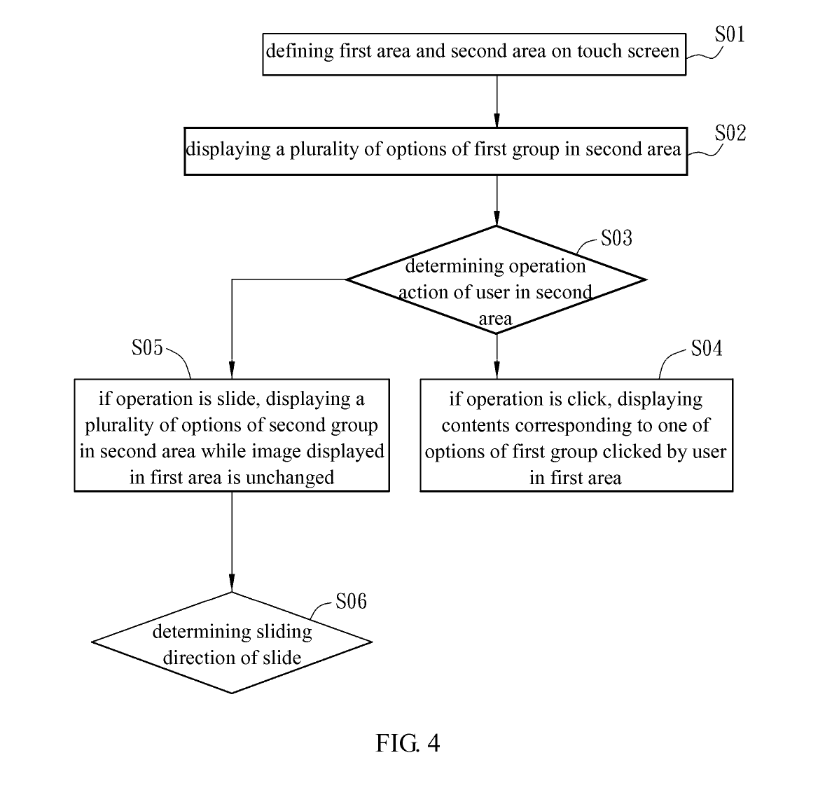

Please refer to FIG. 3A, FIG. 3B, and FIG. 4. FIG. 4 is a flow chart showing a control method of a user interface in another form according to one preferred embodiment of the invention. The control method of the user interface in the embodiment further includes step S06. Therefore, if an operation is a slide, in step S06, a sliding direction of the slide is determined. In the embodiment, a group number of a first group 31 is n, and n is an integer between a minimum value one and a maximum value N. At that moment, if the slide is along a first direction D1 (a downward direction in FIG. 3B), a group number of a second group 32 is n+1. In other words, if the group number of the first group 31 is one, the group number of the second group 32 is two, and the rest can be done in the same manner.

Accordingly, in detail, a user U can slide along the first direction D1 in a second area 92, and the second area 92 may change to display a plurality of options of the second group 32. At that moment, the second group 32 is a set of a plurality of the options with the group number n which is two. However, a first area 91 may still display contents of an option 311 selected by the user U before and may not be affected by the change from the first group 31 to the second group 32 in the second area 92.

Further, at the beginning, when the group number n of the first group 31 displayed in the second area 92 is two, if the user U slides along the first direction D1, the second area 92 may display the second group 32. Further, at that moment, the second group 32 is a set of a plurality of the options with the group number n which is three.

According to the above, in the embodiment, the maximum value N is equal to three. However, the invention is not limited thereto. According to different needs, N may be equal to two or may be greater than three. Therefore, if the user U still slides along the first direction D1, at that moment, since the group number n of the first group 31 is the maximum value N (i.e., N is three), the group number n of the second group 32 may be back to one. In other words, the second area 92 may display the first group 31 as shown in FIG. 3A, and the group number n of the first group 31 is one. That is, the groups respectively having a plurality of the options displayed in the second area 92 are displayed in a circular mode.

Thereby, since the user U can change between different groups having a plurality of the options in the second area 92 via the slide, the second area 92 can contain more options via increasing more groups. Further, since the user U can directly change between different groups via the slide without relying on the additional icon for turning pages in the prior art, the second area 92 can also display larger icons to facilitate the click by the user U. In addition, when the user U operates in the first area 91, the user U can still select a different icon in the second area 92. Thereby, when the user U is to switch to the next application program, he does not need to exit from the former one first, further improving convenience in use.

Further, when the operation is the slide along the first direction D1, the options 311, 312, and 313 of the first group 31 displayed in the second area 92 can respectively present a predetermined effect and change to the options 321, 322, and 323 of the second group 32. The predetermined effect may be turning, rotation, fading out, or a combination thereof. In other words, the options 311, 312, and 313 can sequentially or simultaneously change to the options 321, 322, and 323 via a particular effect such as turning, rotation, fading out, or a combination thereof.

In addition, if the slide of the user is along a second direction opposite to the first direction D1, the group number of the second group 32 is n−1. That is, if the group number n of the first group 31 is two, the group number of the second group 32 is one. Further, in the aforementioned circular displaying mode, when the group number of the first group 31 is one and the slide is along the second direction, the group number n−1 of the second group 32 is the maximum value N. In detail, in the embodiment, the maximum value N is equal to three. However, the invention is not limited thereto. According to different needs, N may be equal to two or may be greater than three. The user U can slide along the second direction (the direction opposite to the first direction D1 in FIG. 3B) in the second area 92. If the group number of the first group 31 is one, the second area 92 may change to display the second group 32 whose group number n is three, while the first area 91 may still display the contents of the option 311 selected before by the user U.

To sum up, according to the control method of the user interface in the embodiments of the invention, the first area and the second area are defined on the touch screen, and a plurality of the options of the first group are displayed in the second area. Therefore, when the user clicks one of the options in the second area, the first area may display the contents corresponding to the option clicked by the user. When the user slides along the first direction in the second area, the second area may display the second group having a plurality of the options while the image displayed in the first area is unchanged.

Since the user can change between different groups in the second area via the slide, the second area can contain more icons via increasing more groups. Further, since the user can directly change between different groups via the slide without relying on the additional icon for turning pages in the prior art, the second area can also display the larger icons to facilitate the click by the user. In addition, when the user operates in the first area, the user can still select different icons in the second area. Thereby, when the user is to switch to the next application program, he does not need to exit from the former one first, further improving convenience in use.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for controlling a user interface of an electronic device, the electronic device having a touch screen, the control method comprising the following steps of:
defining a first area and a second area on the touch screen;
displaying a plurality of options of a first group in the second area;
determining an operation of a user in the second area;
if the operation is a click, displaying contents corresponding to one of the options of the first group clicked by the user in the first area; and
if the operation is a slide, displaying a plurality of options of a second group in the second area while an image displayed in the first area is unchanged.

2. The control method according to claim 1, wherein if the operation is the slide, the control method further comprises the following step of;
determining a sliding direction of the slide.

3. The control method according to claim 2, wherein a group number of the first group is n, and n is an integer between a minimum value 1 and a maximum value N.

4. The control method according to claim 3, wherein if the slide is along a first direction, a group number of the second group is n+1.

5. The control method according to claim 4, wherein if the group number of the first group is N and the slide is along the first direction, the group number of the second group is 1.

6. The control method according to claim 3, wherein if the slide is along a second direction, a group number of the second group is n−1.

7. The control method according to claim 6, wherein if the group number of the first group is one and the slide is along the second direction, the group number of the second group is N.

8. The control method according to claim 1, wherein if the operation is the slide, the options of the first group displayed in the second area respectively present a predetermined effect and change to the options of the second group.

9. The control method according to claim 8, wherein the predetermined effect is turning, rotation, fading out, or a combination thereof.

10. The control method according to claim 1, wherein the first group and the second group represent different functions, respectively.

11. The control method according to claim 1, wherein the options of the first group and the options of the second group represent different functions, respectively.
